(19) United States
(12) Patent Application Publication
(10) Pub. No.: US 2008/0186184 A1
(43) Pub. Date: Aug. 7, 2008

(54) NETWORKED SECURITY TAGS FOR PORTABLE DEVICES

(75) Inventors: Jason August, Toronto (CA); John K. Stevens, Stratham, NH (US); Paul Waterhouse, Copetown (CA)

Correspondence Address: MICHAEL J. BUCHENHORNER, 8540 S.W. 83 STREET, MIAMI, FL, 33143, US

(73) Assignee: Visible Assets Inc., Mississauga (CA)

(21) Appl. No.: 11/762,739

(22) Filed: Jun. 13, 2007

Related U.S. Application Data
(63) Continuation-in-part of application No. 11/633,751, filed on Dec. 4, 2006.
Application No. 11/633,751 is a continuation-in-part of application No. 11/162,907, filed on Sep. 28, 2005.

(51) Int. Cl. G08B 13/14

(52) U.S. Cl. 340/572.7

(57) ABSTRACT

Briefly, according to an embodiment of the present invention, a networked security tag affixed to a portable computing device is operable to provide monitoring, tracking, and security for the portable computing device within a protected region. The security tag includes the following: an onboard security program, an omni-directional device antenna operable at a low radio frequency not exceeding one megahertz, a transceiver operatively connected to the device antenna, the transceiver operable to receive radio signals at the low radio frequency and generate data signals at the said low radio frequency, in response thereto. The security tag also includes a programmable microcontroller operatively coupled with the transceiver, the microcontroller configured for controlling operation of the security program and to cause the transceiver to emit a signal.

### CROSS-REFERENCE TO RELATED APPLICATIONS

This application is a continuation-in-part of U.S. application Ser. No. 11/633,751, filed Dec. 4, 2006, which is in turn a continuation-in-part of U.S. application Ser. No. 11/162,907, “RF Tags for Tracking and Locating Travel Bags,” filed Sep. 28, 2005. This application also claims priority from U.S. application Ser. No. 11/462,844, “Networked RF Tag for Tracking Baggage,” filed on Aug. 7, 2006. This application contains inventive material similar to and related to that contained in co-pending application Ser. No. 11/754,261, “Secure, Networked Portable Storage Device,” filed May 25, 2007.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

Not Applicable.

### Trademarks

RuBee™ is a registered trademark of Visible Assets, Inc. of the United States. Other names used herein may be registered trademarks, trademarks or product names of Visible Assets, Inc. or other companies.

### FIELD OF THE INVENTION

The invention disclosed broadly relates to the field of portable computing devices and more particularly relates to the field of securing portable devices such as laptops.

### BACKGROUND OF THE INVENTION

Portable computing devices such as laptops are commonplace in today's workplaces. Many offices have switched from desktops or towers to laptops for their employees, sometimes for the simple reason that they take up less space in a workstation. Although laptops are portable, many employers restrict their employees from removing the laptops from the office. What makes these devices so attractive is their portability, yet their portability contributes to the difficulty in monitoring them. This problem is exacerbated by the trend towards laptops that are getting progressively smaller and lighter. Consider that last year Sony launched an 898 gram (1.98 pounds) laptop. Fujitsu has introduced a folding laptop that folds into a square roughly the size of a 4×6 photo frame.

Securing the data contained in these laptops means securing the laptops themselves and yet their highly portable form factors make this a difficult task.

Therefore, there is a need for a security device to overcome the aforementioned shortcomings of the known art.

### SUMMARY OF THE INVENTION

Briefly, according to an embodiment of the present invention, a networked security tag affixed to a portable computing device is operable to provide monitoring, tracking, and security for the portable computing device within a protected region. The security tag includes the following: an onboard security program, an omni-directional device antenna operable at a low radio frequency not exceeding one megahertz, a transceiver operatively connected to the device antenna, the transceiver operable to receive radio signals at the low radio frequency and generate data signals at the low radio frequency, in response thereto. The security tag also includes a programmable microcontroller operatively coupled with the transceiver, the microcontroller configured for controlling operation of the security program and to cause the transceiver to emit a signal.

Additionally, the networked security tag is also functional at a low radio frequency not exceeding 300 kilohertz, and in some cases, under 180 kilohertz. The security tag may also include an identification storage section operatively connected to the security program. The identification storage section includes identification data for the portable computing device, and it may optionally include information about the owner of the device and/or the network.

Further, the security tag may contain a small memory for storing data and a timing device. The timing device is operable to activate the transceiver at selected time intervals, and create timestamps that are tied to status events. A temporal history of the status events can be stored in the memory. The timing device may be a crystal providing random phase modulation for enabling a selective read of a specific security tag within a network of tags.

Further, the security tag may include at least one sensor for detecting at least one condition. The sensor may be operable to emit an on-demand transmission signal when the at least one condition is detected. The microcontroller is able to detect and read the sensor signal and take appropriate action. The at least one sensor may be a global positioning system sensor for locating the portable computing device.

Further, to increase the functionality of the security tag, it can be operatively connected to a hard drive controller in the portable computing device. At least one switch can be set to remain in an enable mode for a predetermined interval of time, responsive to signals from the base station. The switch is set to disable mode once the predetermined interval of time has elapsed. A heat-generating device for causing erasure of data in the portable computing device is actuated by the microcontroller in response to receipt of an erase signal, the erase signal emitted if the portable computing device is removed from the protected region.

Further, an energy source such as a battery within the security tag can be maintained in sleep mode until activated by the microcontroller to set a switch indicating that access to data in the portable computing device should be restricted. The energy source may also activate a heat-generating device to destroy the data in the portable computing device.

According to an embodiment of the present invention, a method for securing data in a portable computing device within a protected region includes steps or acts of: configuring a signal generating system within the protected region to include at least one field antenna and a base station operable to generate a low frequency radio signal not exceeding one megahertz; configuring the portable computing device with a security tag; monitoring the portable computing device within the protected region; enabling user access to the data in the portable computing device when the portable computing device is within the protected region; and restricting user access to the data in the portable computing device when the portable computing device is outside of the protected region.

According to an embodiment of the present invention, a system for tracking, monitoring, and securing at least one portable computing device within a protected region includes: a networked security tag affixed to each portable computing device, the security tag operable to receive and transmit signals at a low radio frequency not exceeding one megahertz; a base station operable to generate the low radio frequency signals throughout substantially the entirety of the protected region; and at least one field antenna for radiating the low frequency radio signals driven by the base station.

Further, the system may include a computer for monitoring the at least one portable computing device, and a portal configured to read data from the security tag.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is an illustration of an exemplary portable computing device and an affixed security tag, according to an embodiment of the present invention;

FIG. 2 is a simplified block diagram of a security tag with optional components, according to another embodiment of the present invention;

FIG. 3 is a simplified block diagram of a protected region wherein a portable device with an attached security tag may be advantageously used, according to an embodiment of the present invention;

FIG. 4 is a simplified illustration of one possible placement of the tag, according to an embodiment of the present invention;

FIG. 5 is a flowchart of a method for securing a portable computing device, according to an embodiment of the present invention;

FIG. 6 is a flowchart of another method for securing a portable computing device, according to an embodiment of the present invention;

FIG. 7 is a simplified block diagram of a security tag with the security program housed in the microcontroller, according to another embodiment of the present invention;

FIG. 8 is a flow chart of a method for securing data, according to another embodiment of the present invention;

FIG. 9a shows placement of an antenna, according to an embodiment of the present invention;

FIG. 9b shows another placement of an antenna, according to an embodiment of the present invention;

FIG. 10 shows a free-standing portal for exit control, according to an embodiment of the present invention;

FIG. 11 shows a wall-mounted portal for exit control, according to an embodiment of the present invention;

FIG. 12 is a flow chart of a method for exit control using a portal, according to an embodiment of the present invention;

FIG. 13 is a portable device with an additional battery, according to an embodiment of the present invention; and

FIG. 14 is a simplified diagram of components of a portal configured to operate according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

A solution to the problem of unauthorized removal of a portable computing device from a secure region is discussed with reference to the figures. According to an embodiment of the present invention, a portable computing device is secured using a low frequency radio tag configured with the RuBee™ IEEE P1902.1 “RuBee Standard for Long Wavelength Network Protocol” to safeguard the portable computing device. It may be desirable to safeguard the device so as to protect data contained in the device, such as data in the hard drive. There are many reasons why a user of the portable computing device or an administrator in an office where the portable computing device is used may need to keep the device protected from unauthorized access. For example, the data in the device may be of a personal nature, or it may be subject to strict confidentiality and audit trail protocols, such as data in a medical file. The latter reason is most commonly found in governmental offices, the healthcare industry, the military and corporations that do business with the government, hospitals, and/or the military.

The computing device as will be described herein can be configured as part of a network and can be operable to receive and transmit signals to/from other computing devices within the network, whether those devices are portable or not. See “Networked Ear Tags for Tracking Animals,” application Ser. No. 11/735,959, filed on Apr. 16, 2007. See also “Two-Tiered Networked Identification Cards,” Application Ser. No. 60/889,902, filed on Feb. 14, 2007. See also co-pending “Secure, Networked Portable Storage Device,” application Ser. No. 11/754,261, filed on May 25, 2007.

The method for securing a portable computing device as will be described herein enables the protection/tracking/control of portable devices within a secured network, using low frequencies. A secured network can be any portion of any building, classified site or other region wherein the portable devices may be securely used. The protection/tracking/control capabilities within the secured network are not hampered by any surrounding metal, water and masonry which can interfere with reliable transmissions at high frequencies. To understand how the security features are enabled, we discuss the RuBee™ long wavelength network protocol.

RuBee™ Tag Technology.

Radio tags communicate via magnetic (inductive communication) or electric radio communication to a base station or reader, or to another radio tag. A RuBee™ radio tag works through water and other bodily fluids, and near steel, with an eight to fifteen foot range, a five to ten-year battery life, and three million reads/writes. It operates at 132 kHz and is a full on-demand peer-to-peer, radiating transceiver.

RuBee™ is a bidirectional, on-demand, peer-to-peer transceiver protocol operating at wavelengths below 450 kHz (low frequency). A transceiver is a radiating radio tag that actively receives digital data and actively transmits data by providing power to an antenna. A transceiver may be active or passive.

Low frequency (LF), active radiating transceiver tags are especially useful for visibility and for tracking both inanimate and animate objects with large area loop antennas over other more expensive active radiating transponder high frequency (HF)/ultra high frequency (UHF) tags. These LF tags function well in harsh environments, near water and steel, and may have full two-way digital communications protocol, digital static memory and optional processing ability, sensors with memory, and ranges of up to 100 feet. The active radiating transceiver tags can be far less costly than other active transceiver tags (many under one US dollar), and often less costly than passive back-scattered transponder RFID tags, especially those that require memory and make use of an EEPROM. With an optional on-board crystal, these low frequency radiating transceiver tags also provide a high level of security by providing a date-time stamp, making full AES (Advanced Encryption Standard) encryption and one-time pad ciphers possible.

One of the advantages of the RuBee™ tags is that they can receive and transmit well through water and near steel. This is because RuBee™ operates at a low frequency. Low frequency radio tags are immune to nulls often found near steel and liquids, as in high frequency and ultra high-frequency tags. This makes them ideally suited for use in office environments where metal is commonly used in shelving and in construction. Fluids have also posed significant problems for current tags. The RuBee™ tag works well through water. In fact, tests have shown that the RuBee™ tags work well even when fully submerged in water. This is not true for any frequency above 1 MHz. Radio signals in the 13.56 MHz range have losses of over 50% in signal strength as a result of water, and anything over 30 MHz have losses of 99%.

Another advantage is that RuBee™ tags can be networked. One tag is operable to send and receive radio signals from another tag within the network or to a reader. The reader itself is operable to receive signals from all of the tags within the network. These networks operate at long-wavelengths and accommodate low-cost radio tags at ranges to 100 feet. The standard, IEEE P1902.1™, “RuBee Standard for Long Wavelength Network Protocol”, allows for networks encompassing thousands of radio tags operating below 450 kHz.

The inductive mode of the RuBee™ tag uses low frequencies, 3-30 kHz VLF or the Myriametric frequency range, 30-300 kHz LF in the Kilometric range, with some in the 300-3000 kHz MF or Hectometric range (usually under 450 kHz). Since the wavelength is so long at these low frequencies, over 99% of the radiated energy is magnetic, as opposed to a radiated electric field. Because most of the energy is magnetic, antennas are significantly (10 to 1000 times) smaller than ¼ wavelength or 1/10 wavelength, which would be required to efficiently radiate an electrical field. This is the preferred mode.

As opposed to the inductive mode radiation above, the electromagnetic mode uses frequencies above 3000 kHz in the Hectometric range, typically 8-900 MHz, where the majority of the radiated energy generated or detected may come from the electric field, and a ¼ or 1/10 wavelength antenna or design is often possible and utilized. The majority of radiated and detected energy is an electric field.

RuBee™ tags are also programmable, unlike RFID tags. The RuBee™ tags may be programmed with additional data and processing capabilities to allow them to respond to sensor-detected events and to other tags within a network.

Portable computing device configured with security tag.

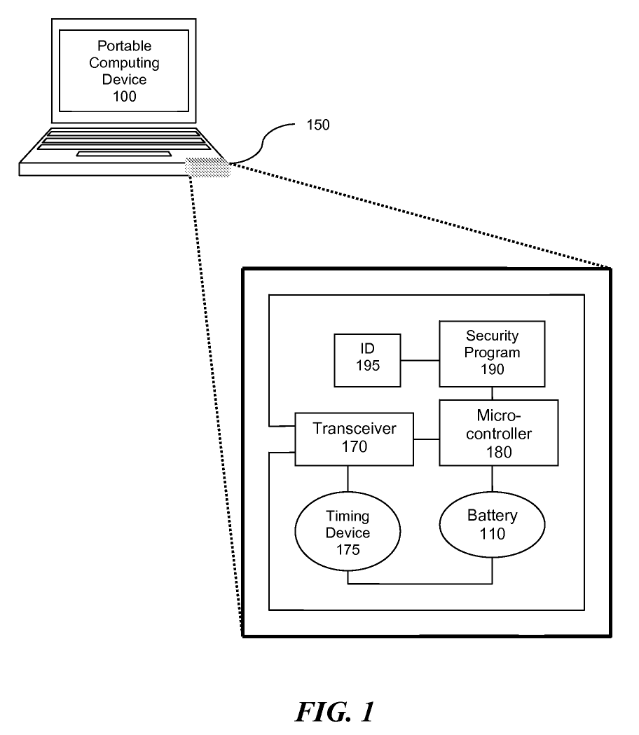

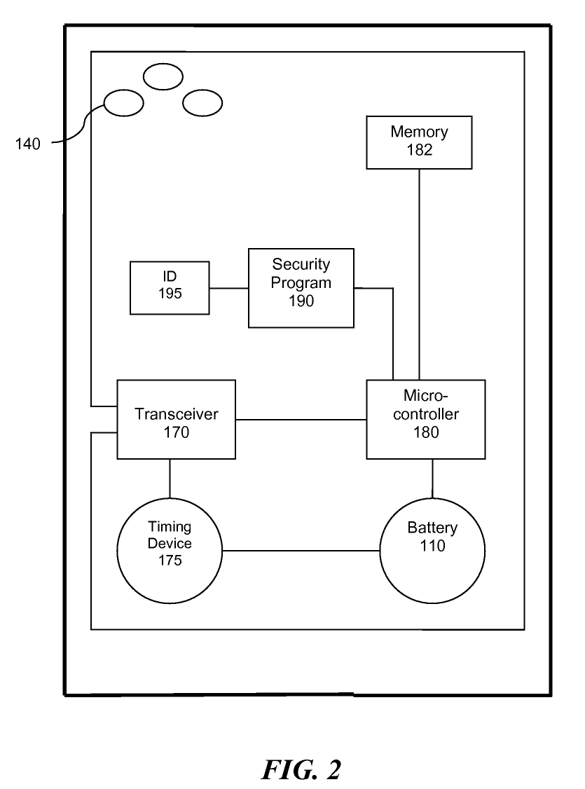

Referring now in specific detail to the drawings, and particularly FIG. 1, there is illustrated an exemplary portable computing device 100 according to an embodiment of the present invention. The portable computing device 100 as shown and described herein is a laptop; however, any portable device used to manipulate data may be envisioned within the spirit and scope of the invention. The device 100 includes the standard components found in most laptops. In order to monitor, track, and secure the laptop 100, a RuBee™-enabled security tag 150 is affixed to the laptop 100. The security tag 150 can be affixed to the outside housing of the laptop 100 or stored inside the laptop 100. The tag 150 contains the following components:

RuBee™ transceiver 170. The transceiver 170 is operatively connected to the antenna 160 and the microcontroller 180. The transceiver 170 is preferably a custom radiofrequency modem, created on a custom integrated circuit using 4 micron complementary metal oxide semiconductor (CMOS) technology designed to communicate (transmit and receive radio signals) through the omni-directional loop antenna 160. All communications take place at very low frequencies, under 300 kHz, and possibly as low as 180 kHz. By using very low frequencies the range of the tag 150 is somewhat limited; however power consumption is also greatly reduced. Thus, the receiver 170 may be on at all times and hundreds of thousands of communication transactions can take place, while maintaining a life of many years (up to 15 years) for the battery 110. The range of the transceiver 170 can be augmented by the use of field antennas.

A microprocessor or microcontroller 180 controls the operation of the security program 190. The microcontroller 180 may be a standard original equipment manufacture (OEM) microprocessor. It may be created on a custom integrated circuit using four micron CMOS (complementary metal-oxide semiconductor) technology. The microcontroller 180 is operatively connected to the transceiver 170, and the security program 190. It has the ability to detect and read analog voltages from various optional detectors.

A security program 190 is operatively connected to the microcontroller 180. The security program 190 contains program code instructions to provide security for the laptop 100. The program code instructions may be customized by a user in order to perform functions including, but not limited to: 1) allow a user to read/write data to the laptop 100; 2) prevent a user from reading/writing to the laptop 100; 3) disable the memory in the laptop; 4) provide identification data when requested.

The security program 190 may be embodied as program code instructions embedded in a control program, or it may be a separate application. The security program 190 may be embodied as software only, hardware, or firmware. The security program 190 may be embodied as an application specific integrated circuit (ASIC). There may be more than one security program 190 to handle different security measures. For example, one security program is strictly for disabling the device 100 and one security program monitors access requests.

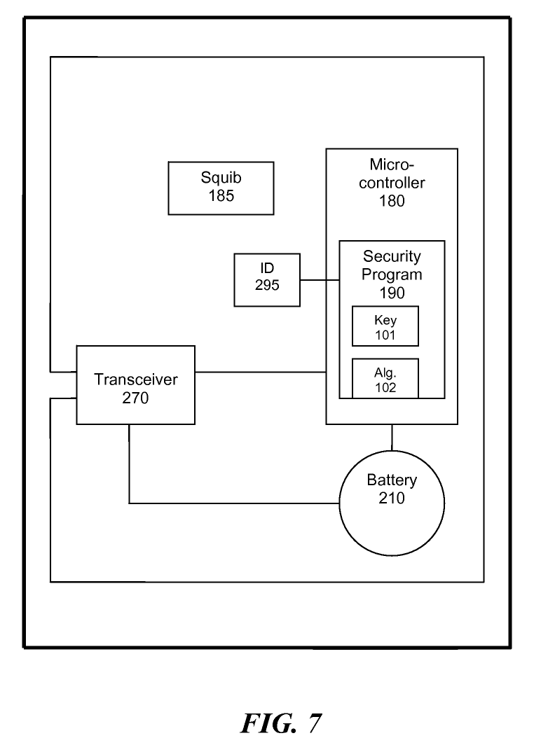

In another embodiment as shown in FIG. 7, the security program 190 may be stored in the microcontroller 180, as software, hardware and/or firmware, as shown in FIG. 7. The components may be placed in any number of configurations.

The energy source 110 for the tag 150 may be a battery (e.g., battery, solar cell, and induction coil/rectifier) operable to energize the transceiver 170 and the microcontroller 180 as well as to enhance the power of the transmission to and from a reader. The battery 110 as shown in FIG. 1 is preferably a lithium (Li) CR2525 battery approximately the size of an American quarter-dollar with a five to fifteen year life and up to three million read/writes. Note that only one example of an energy source is shown. The tag 150 is not limited to any particular source of energy; the only requirement is that the energy source is small in size, lightweight, and operable for powering the electrical components. The battery 110 may also serve to power optional components such as sensors.

Tag antenna 160. The antenna 160 is a small omni-directional loop antenna with an approximate range of eight to fifteen feet. It is preferably a thin-gauge wire wrapped many times around the inside edge of the tag housing. A reader or monitor may be placed anywhere within that range in order to read signals transmitted from the tag 150. If data is stored in the tag 150, the tag 150 may use metal gate CMOS or optionally silicon gate CMOS technology, since it operates at such a low frequency. In most cases the cost of the battery (6 cents), and an optional crystal (4 cents) and CMOS chip (5-10 cents) is less than an EEPROM chip with less than 24 bytes of memory.

Optional Components.

On-board memory 182 may be used to store data about events. In combination with a crystal, the memory 182 may store a temporal history of status events tied to a timestamp, as is well-known in the art.

A timing device 175 is used to activate the transceiver 170 at selected time intervals to detect a presence of low frequency radio signals. The timing device 175 may also be used by the transceiver 170 to emit low frequency radio signals at predetermined time intervals.

The timing device 175 may be a crystal. The crystal 175 may be used to provide a frequency reference. In a preferred embodiment we use a 32 kHz crystal commonly used in watches or devices that require a timing standard. This is used as a frequency reference for transmission of date and time. The crystal 175 serves as a timing reference or clock for recording date and time. This makes it possible for the tag 150 to create logs and records of activity and other parameters. It also provides for a dynamic proof of content that can be changed periodically. The crystal 175 also provides for the ability for the tag 150 to become an “on demand” client to transmit when a specific condition is met or an optional sensor value is exceeded without the need of a reference carrier. The crystal frequency may be multiplied four times to achieve a transmission frequency of 128 kHz.

The crystal 175 also provides for random phase modulation. Passive and other active tags all use a transponder mode and use carrier frequency as a reference. Thus, the crystal 175 is viewed as unnecessary in other tags and is eliminated to save cost and space. However, the crystal 175 as used in the security tag 150 provides for the ability to selectively read one tag 150 within an area, without prior knowledge of its ID. This random phase and “network discovery” is enabled by the use of the crystal 175 as opposed to anti-collision methods used in other radio tags.

Sensors 140. In addition, low cost detectors 140 for environmental parameters (humidity, angle, temperature) and activity parameters (acceleration and jogs) and an on-board GPS (global positioning system) sensor may be easily added to the security tag 150 as needed. With the addition of internal memory 182 such as a data storage device, data associated with these detectors 140 may be logged over time and stored in the tag 150 for reading and documenting the history of the laptop 100. More importantly these electronic tags 150 could provide detailed times and dates when any data parameter changed or an action took place. For example, it is possible to identify the location and the precise time when a high-value package, such as the laptop 100, was dropped or moved from its location. The use of a sensor 140 for detecting movement is highly recommended for a security tag 150 that is affixed to the outside of the laptop 100.

An advantage of this tag 150 is its ability to transmit to a base station, independent of the base station interrogating the tag 150. This on-demand tag transmission makes it possible for the tag 150 to transmit an alarm signal to the base station when a sensor 140 detects certain conditions, such as the laptop 100 being moved.

An optional identification storage element 195 may be included within the security program 190 or operatively connected to the program 190 as shown in FIG. 1. This storage element 195 stores an identification code identifying the portable device 100. The identification code may also optionally identify the organization or project for which the device is being used and/or the device user. The identification code may be hardwired into the storage element 195 or the security program 190 or it may be programmatically inserted as software by the microcontroller 180 after receiving the code signal from a trusted source. This identification code 195 may contain a unique identifier for the device 100 and it may also contain a network identifier.

This identifier is required when communicating within the network of portable devices and in particular so that devices can communicate with each other with some degree of certainty that they are communicating with a trusted device. The transceiver 170 is operable to wirelessly transmit the identification code to a requesting entity such as a monitoring station.

Each security tag 150 may have many IDs programmed into its memory. A handheld or a special programming device (a base station) connected to a computer with limited range, sends out a unique ID. The tag 150 has an always-on receiver and reads the transmitted ID, it compares this with the IDs contained in its memory and if it finds a match, transmits a signal containing the transmitted ID back to the transmitter, indicating that it is now fully open to handle communication. The base station may then provide the security tag 150 with one or more unique ID numbers which may simply be a unique tracking number, or other unique ID, as well as any information it may require to function (e.g. instructions to log temperature or physical impacts such as jogs). The tag 150 is also provided with several random numbers stored in its memory that can be used to delay un-solicited transmissions to the base station to minimize likelihood of collisions.

A squib device 185 is shown in FIG. 7. A squib 185 in this context is a device for erasing stored data by permanently physically damaging a data storage device using heat. The squib 185, as known to those with knowledge in the art, may be activated by a signal from the microcontroller 180, igniting a pyrotechnic material, thus permanently and irrevocably damaging a memory device. The microcontroller 180 can be programmed to emit this erase signal when a status event occurs. In this context, a status event may be detection that the device 100 is being removed from a secure area or that the device 100 is being moved.

Placement of Security Tag.

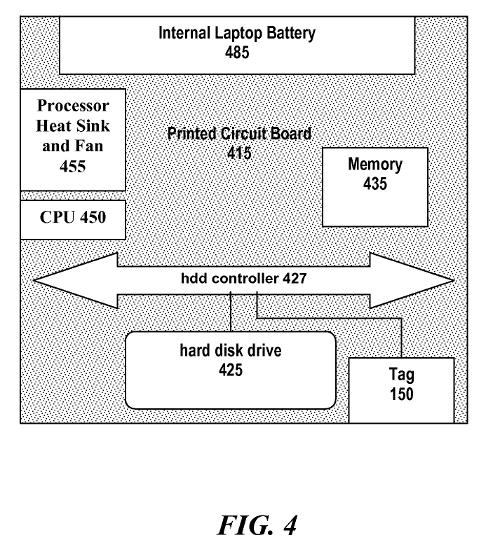

Referring to FIG. 4 there is shown a simplified illustration of the internal components of the laptop 100 of FIG. 1, specifically the printed circuit board 415, the internal battery 485, memory 435, the CPU 450, the processor heat sink and fan 455, and the hard disk drive 425. A hard drive controller 427 (scsi or ide) controls the hard drive 425. For clarity, we have shown only the most basic components of a laptop. Those with knowledge in the art will appreciate that a modern laptop will house various drivers, interfaces, buses, ports, controllers, and additional memory that are omitted from this illustration. The tag 150 is shown here placed inside the laptop 100, operatively connected to the controller or bus 427. Note this is only one possible configuration showing how the tag 150 can be positioned inside of a laptop. The connection between the tag 150 and the controller 427 is optional. The tag may be placed inside the laptop 100 as shown in FIG. 1 or it may be affixed to the outside housing of the laptop 100.

Protected Region.

According to a preferred embodiment, the device 100 is fully operable when used within a protected region, such as a building, provided with a signal generating system operable to generate a low frequency radio signal not exceeding one megahertz throughout substantially the entirety of said protected region by radiating said low frequency radio signal from at least one field antenna which is driven by a base station. The protected region may be as small as a desk area, a single office or lab, or as large as a multi-building complex. The size of the protected region can be increased exponentially with the addition of field antennas and base stations.

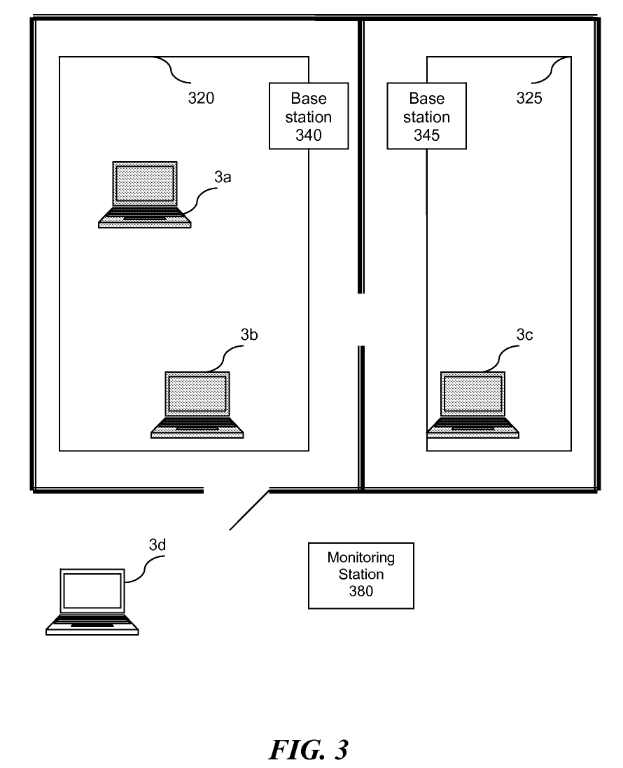

Referring to FIG. 3 there is shown an exemplary illustration of a protected region wherein the portable device 100 may be advantageously used. In this protected region 300 (shown here as a building) there are four networked portable devices. Three portable devices 3a, 3b, and 3c are shown within the protected region 300. Portable device 3d is shown outside of the protected region 300.

Also shown is a signal generating system that includes field antennas 320 and 325. These field antennas are in communication with base stations 340 and 345. The field antennas are basically large loop antennas that can be placed around the perimeter of the office, or around shelving. They may be made from medium gauge wire (10-12 gauge) with several turns around the loop. The transmission distance of the tag 150 can be controlled by the size of the loop. For example the loop may be small, a foot by one foot, and a tag 150 may be read or written to within that area and within several feet surrounding the area. Alternatively, the loop may cover a large area, 100×100 feet for example. In this case the security tag 150 may be read or written to anywhere within the 100 sq. foot area, as well as 20 to 30 feet beyond the loop's edge outside of the central area. It will be understood that the placement of the field antennas 320 and 325 shown in FIG. 3 are exemplary and are not meant to restrict the scope of the invention to this particular placement and configuration of field antennas.

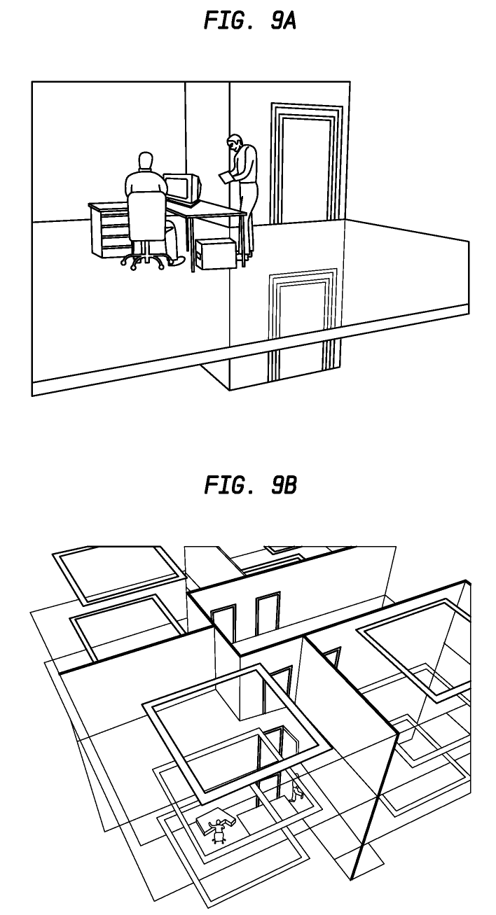

Field antennas may be placed horizontally, vertically, in and around metal shelving, walls and workstations, under carpeting and above ceiling tiles. They may be placed around a doorway, as shown in FIG. 9a. In another embodiment as shown in FIG. 9b, the antenna may be placed horizontally either on a floor or ceiling within a building or even an outdoor area. The RuBee™ low frequency signals are ideal for this configuration because the metal in door jambs or walls will not interfere with the signals as they would with RFID. For aesthetic reasons, the field antennas 320 and 325 can be placed so that they are hidden from view, without losing transmission strength.

The base stations 340 and 345 generate a low frequency radio signal (less than one megahertz) throughout the entire protected region 300. The protected devices can respond to these signals by emitting radio signals less than 300 megahertz. The number of base stations and field antennas can be increased or decreased depending on the amount of area to protect. The example of FIG. 3 depicts a configuration similar to that which would be used in a medium-size office. A monitoring station 380 such as a server with web access monitors the portable devices within the protected region 300. The monitoring station 380 may be located outside of the protected region 300. The status of the protected devices within the secure area 300 may be monitored by security personnel outside of the secure area 300 via an intranet or through the Internet. A server may be used to track all portable devices and issue alerts if a security event is detected, such as the device exiting the secure area 300.

The base station 340, or router, is a custom RuBee™ router. It consists of some basic logic circuitry, a radio modem circuit, and an antenna. RuBee™ routers are designed to read data from multiple antennas at a low frequency. The base station 340 may be configured with a built-in GPS unit, multiple USB ports, a serial port and high-speed Ethernet connection for communication with a central data processor or monitoring station 380. This configuration has the added benefit that not only does it track and protect the portable devices, but it can enable any data stored in the memory 182 of the portable devices 3a, 3b, and 3c to be accessed remotely via a web-enabled computer 380.

At any point in time, data stored in any of the portable devices within the network can be accessed real-time through a web browser. One with knowledge in the art can understand that the data may also be encrypted and/or password-protected so that only authorized users may access the data through the web browser. The data can be protected by assigning a personal identification number (PIN) so that only those users with the PIN can access the data. Alternatively, the data may be encrypted with Advanced Encryption Standard (AES) encryption. Only authorized personnel would have the key to decrypt the data.

The base station 340 in the office 300 communicates with the many tags located in the office via a tuned loop antenna 320. A server optionally attached to the base station 340 sends as part of its transmission the tracking number or unique ID to the entire network of tags, and that number is compared by each tag to the numbers contained in each tag's memory. If the tag 150 does find a match for the transmitted number, then the tag 150 replies to the interrogation with that serial number or with the same ID or tracking number. Provided the numbers are unique only a single tag will reply, and full hand-shake communication can be carried out between the tag 150 and the base station 340. At the end of the transmission, the base station 340 sends a code to indicate it has completed all communication. The server 380 can do a check-up on all tags by simply polling each tag one after the other with its ID in the same manner as outlined above. The base station 340 may also read and/or harvest any logs stored in the individual tag's memory 182.

The security tags 150 may also initiate communication, by transmitting their ID's to the base station 340. This could be in response to sensor 140 activation or other event. In the rare case when two tags simultaneously transmit, the IDs will be non-readable and the base station 340 will send out a signal indicating an error has occurred. Two possible protocols may be initiated. The tags may be instructed to re-transmit, using a random delay stored in each tag's memory register, to eliminate the overlap. Alternatively, that server may simply poll all security tags in the field, one-by-one, until it locates the two tags that transmitted the signals.

Method Embodiments.

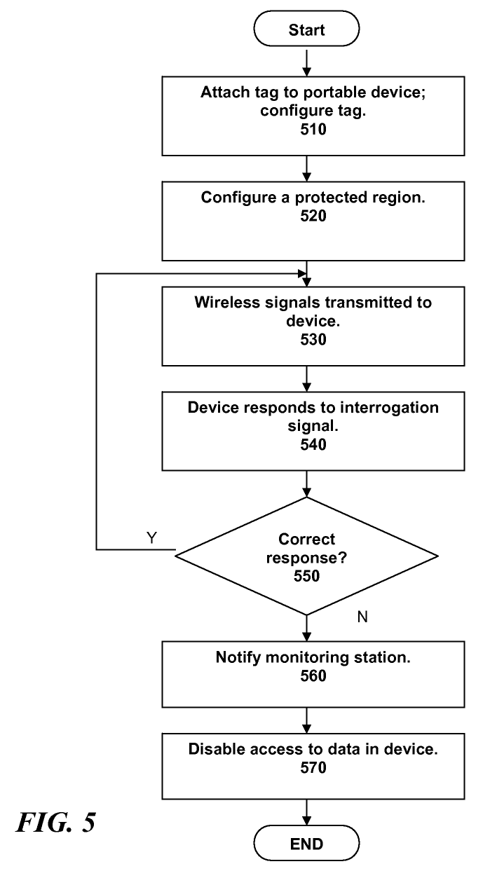

Referring to FIG. 5 there is shown a flow chart 500 detailing a process of securing the laptop 100 in the protected region 300 according to an embodiment of the present invention. The first two steps of the method can be performed in any order. The ordering is not important. Step 510 is to configure a portable computing device with a RuBee™ tag 150. Configuring the device may mean installing the tag 150 inside the device 100 (the preferred method) or affixing the tag 150 to the outside of the device 100.

Step 520 sets up at least one base station and at least one field antenna in the region to be protected. Any area surrounded by a field antenna is considered a protected region. The field antenna may be a loop antenna placed horizontally on the ground, on the ceiling, or around shelving or other structures. The field antenna may also be placed vertically, perhaps along a column or a room divider. The field antenna may also be placed outdoors, perhaps at the outside exit to a building, or a courtyard between buildings.

In step 530, the portable device 100 receives wireless signals from base station 340. The base station 340 may continually radiate interrogation signals (chirps) followed by a listening interval. In another mode the base station 340 radiates interrogation signals intermittently, in burst mode. The signals may be requesting identification information 195 from the portable device 3a. The device 3a receives an interrogation signal which it has been preprogrammed to accept. The device 3a responds to the interrogation signal with a preprogrammed response. The response may simply be an acknowledgment signal or some identifying information.

In step 540 devices within range of the interrogation signal respond to the interrogation signal. The perimeter of the protected region 300 is set up so that any tag 150 within that perimeter is within range of an interrogation signal. If the signals from the portable devices are found to be acceptable in step 550, then nothing occurs and the process loops back to step 530. If, however, the base station 340 receives an incorrect response or no response at all from any of the portable devices, then in step 560 the base station transmits a signal to a monitoring station 380. The monitoring station 380 may then issue a directive to disable any access to the data contained in the non-responding portable device 100 in step 570. Note that step 570 is an optional step. Rather than involve the monitoring station 380, the base station 340 may be programmed to emit the directive to cause the data in the device 100 to be disabled if no response is received, or if the correct response is not received. For expediency, it may be convenient to bypass the step of notifying the monitoring station 380; but by bypassing the monitoring station 380, you may lose the opportunity to acquire some data about the non-responding device 100.

The data may be disabled remotely and wirelessly by activating a squib 185 sensitive to electromagnetic signals, as discussed earlier. The squib 185 destroys the stored data when activated. Therefore, by using a squib 185, any removal of the device 100 from a protected area 300 causes the data to become useless.

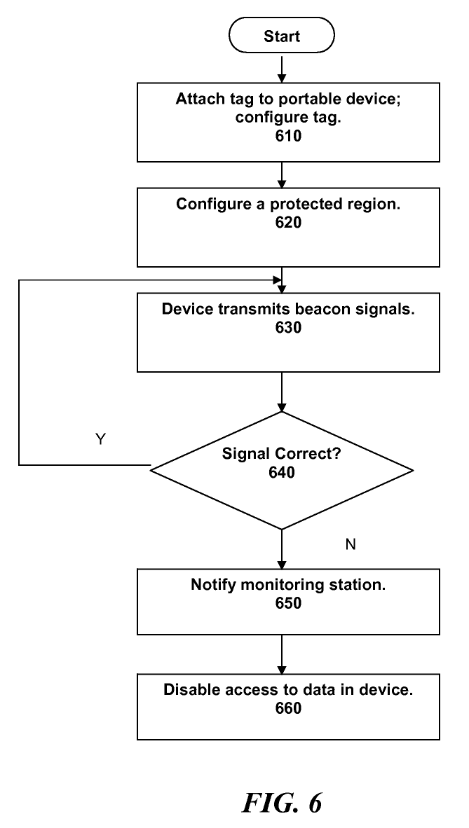

Referring now to FIG. 6, we provide a flow chart 600 representing an alternate method for securing data in the portable device 100. In this embodiment, the first two steps 610 and 620 are the same as the first two steps of FIG. 5. In step 630, the tag 150 emits a low frequency identification beacon signal at timed intervals, using the timing device 175. The low frequency signals (under 150 kHz) are picked up by the field antennas. These beacon signals emitted from each device provide identity information (which may or may not be encoded). This information can be stored or displayed by the monitoring station 380.

The base station 340 is programmed to expect the beacon signal at certain intervals. The base station 340 also has a timer synchronized with the timer 175 of the tag 150.

In step 640 if the pre-determined period of time has elapsed and no signal has been received from the tag 150, then in step 650 the base station 340 will notify the monitoring station 380 to restrict access to the laptop data. Or, in the alternative, as discussed earlier, the base station 340 may be operable to disable the device 100. In step 660 the tag 150 receives a directive to restrict access to the data in the device 100. Just as in FIG. 5, the step of notifying the monitoring station 380 is an optional step.

The beacon signal can provide identifying information for the portable device 100. Using directional antennas and an optional GPS system with a GPS sensor 140 located on the tag 150, the specific location of the device 100 can be computed. This information may be sent to the monitoring station 380 or to a security system where it is stored.

In a preferred embodiment of the present invention, a simple timing method can be used to assure that data access to the portable device 100 is enabled only within the protected region 300. This embodiment requires that the tag 150 include a switch 104. The tag 150 is pre-programmed to maintain the switch 104 or flag setting for a preset interval of time, perhaps 30 seconds, responsive to a signal from the base station 340. This switch setting indicates that data access should be enabled. The base station 340 sends a directive periodically (within a pre-set time frame), instructing the processor 180 to maintain the switch setting to “on” for another thirty seconds. The hard drive controller 427 is programmed to intercept read/write requests to the hard drive 425 and check this switch 104 whenever it receives the read/write request. If the switch 104 is set to the “on” position, the read/write requests are routed to the hard drive 425 as usual.

However, once the pre-determined interval of time elapses (thirty seconds) and the tag 150 has not received any signal from the base station 340, the microprocessor 180 re-sets the switch 104 to indicate that read/writes should be denied. Now when the hard drive controller 427 checks the switch 104, it will find that the switch 104 is set to a setting indicating that no read/writes should be allowed (disable mode); therefore, no read/write requests will be routed to the hard drive 425. This effectively renders the laptop 100 useless. This will occur whenever the laptop 100 is out of range of the base station 340 because the tag 150 cannot receive transmissions from the base station 340 if it is outside of the protected region 300.

To further secure the data in the laptop 100, programming could ensure that once the switch 104 has been set to “disable” mode, it cannot be reset by anyone other than an administrator. This will prevent a situation where the laptop 100 is removed from a secure area 300, its contents are tampered with, and then the laptop 100 is returned to the secure area 300. This timing embodiment may be the easiest and cheapest to implement because it does not require the use of a monitoring station, just the strategic placement of field antennas and a base station. Those with knowledge in the art can appreciate that the switch 104 may be manual, or electronic, and that it may be a combination of switches and the switches may have multiple settings for different levels of access. Those with knowledge in the art will also appreciate that the switch 104 may be placed outside of the tag 150 and still be activated by the tag 150.

The choice of radio frequencies for transmitting and receiving in the secure region is important. A low radio frequency such as 150 kHz can be used for the interrogation signal at the base stations to prevent interference from metals and liquids which may be present in the protected region 300. Operating at such a low frequency allows for transmission of signals in harsh environments. The tag 150 may use the lower frequency (150 kHz) to emit signals to the field antennas or to other devices.

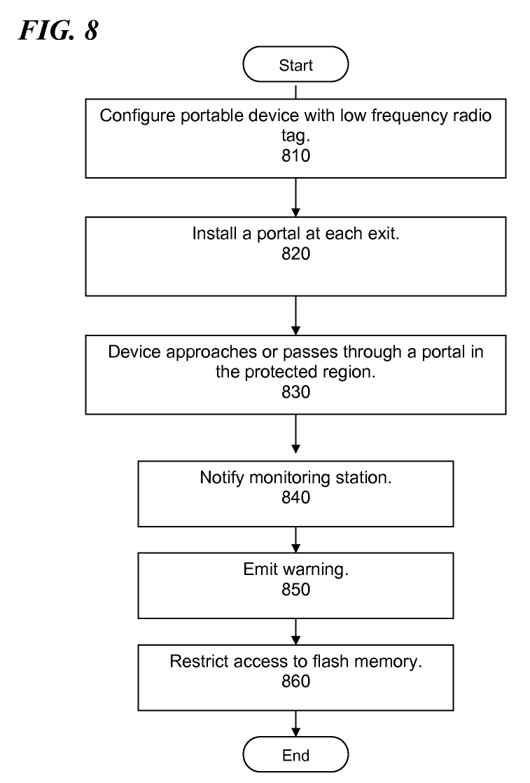

Referring now to FIG. 8 there is shown a flow chart detailing a method of exit control according to another method embodiment of the present invention. In the method 800 of FIG. 8, the first step 810 is the same as step 510 of FIG. 5. In step 820 a visibility portal is installed at each exit to the protected region. In step 830 the portable device 100 passes through the portal or approaches the portal. Next, in step 840 the monitoring station 380 or computer receives a transmission that the device 100 is exiting the secure area.

At this point, in optional step 850, an audio/visual system located within the portal may be prompted to deliver a warning to the person carrying the portable device. The warning may be in the form of an audio alert, such as “Warning! Leaving restricted area” or a text display, flashing light, or any other attention-getting presentation. If the portable device 100 continues to exit the protected region 300 access to its data is disabled in step 860. The tag 150 itself may emit a warning signal when within range of the portal. The tag 150 may be programmed to emit a warning signal when attempting to download material in an area where access is restricted or if the device 100 is removed from the monitored area 300.

Sometimes it is necessary to completely remove sensitive data from a computer rather than just restricting access to the data. This process is known in the art and is generally known by the terms of disk sanitizing, cleaning, purging, or wiping. Three common techniques available for disk sanitization are: overwriting, degaussing, and destruction.

Overwriting a disk can be simply accomplished by issuing a format command. Or, garbage can be written into the memory of the laptop 100. Degaussing erases the servo tracks written on the drive at the factory, using a powerful magnetic field. A degaussed disk cannot be reused. Destroying the disk can be done using a squib 185 as discussed earlier.

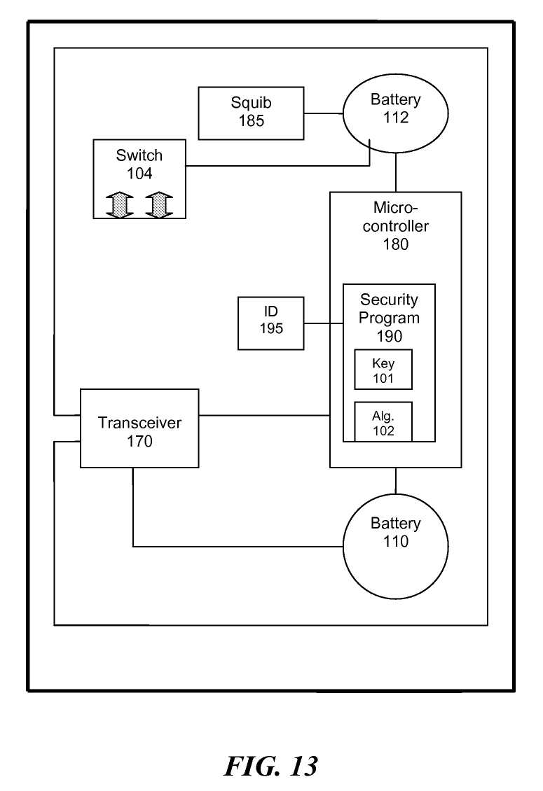

Using the security tag 150, the hard drive 425 can be overwritten if the tag 150 is operatively coupled with the drive controller 427. Then, it is a matter of the microcontroller 180 turning on a switch 104 in the tag 150. The controller 427 is programmed to check the position of this switch 104 before responding to any read/write requests. If the switch 104 is set to the “On” position, the controller writes garbage into the drive 425. The switch 104, as shown in FIG. 13, can have multiple positions. One position may mean “overwrite,” another position may mean, “disable,” another position may mean “normal operation.”

Implementing a degaussing operation using the security tag 150 can be done, but it requires the installation of a degaussing device. In this embodiment, the controller 427 checks the switch 104. If it is set to “disable” (switch positions must be pre-programmed into the controller 427), the controller 427 activates the degaussing device. This type of operation can be costly because of the cost of degaussers and it may not be as practical as other methods.

Destroying the hard drive 425 can be done using the squib device 185. The squib device 185 is shown placed inside the tag 150, but optionally it may be placed outside of the tag 150 next to the hard drive 425. Activating the squib 185 produces enough heat and/or electromagnetic radiation that the hard drive 425 will be rendered inoperable.

There are many circumstances where it may be practical to restrict access to the data without destroying the data. One way to do this is to restrict access to the data by requiring the user to provide a security code. This is done by configuring the device 100 so that any data access requests to the laptop 100 are first routed through the security program 190. The programming in the laptop 100 may require the user to enter a security code, which is then verified by the security program 190.

The security code can then be changed without the user's knowledge if the device 100 leaves the protected region 300. Another way to do this is to periodically update the security code and transmit it to the tag 150 only if the tag 150 answers an interrogation signal.

Another way to restrict data access without destroying the data is easily done by using a conventional encryption/decryption method. Referring again to FIG. 7, an administrator generates a key and then provides a copy 101 of that key to the security tag 150. The key 101 may be stored in the security program area 190, along with the encryption algorithm 102 used to encrypt the data. The key 101 is available to automatically decrypt the data while the device 100 is within the protected region 300. If the device 100 leaves the protected region 300, a signal is sent to the microprocessor 180 to destroy the key 101. The data itself is still safe within the device 100. At this point only the administrator is able to access the data, using the original key. Note that this method will only work if the controller 427 has been programmed to intercept any read/write requests and query the tag 150.

Another way to keep track of the portable device 100 is by using global positioning system (GPS) signals. An optional GPS sensor 140 in the tag 150 can be used by a GPS system to locate the tag 150, thus locating the device 100.

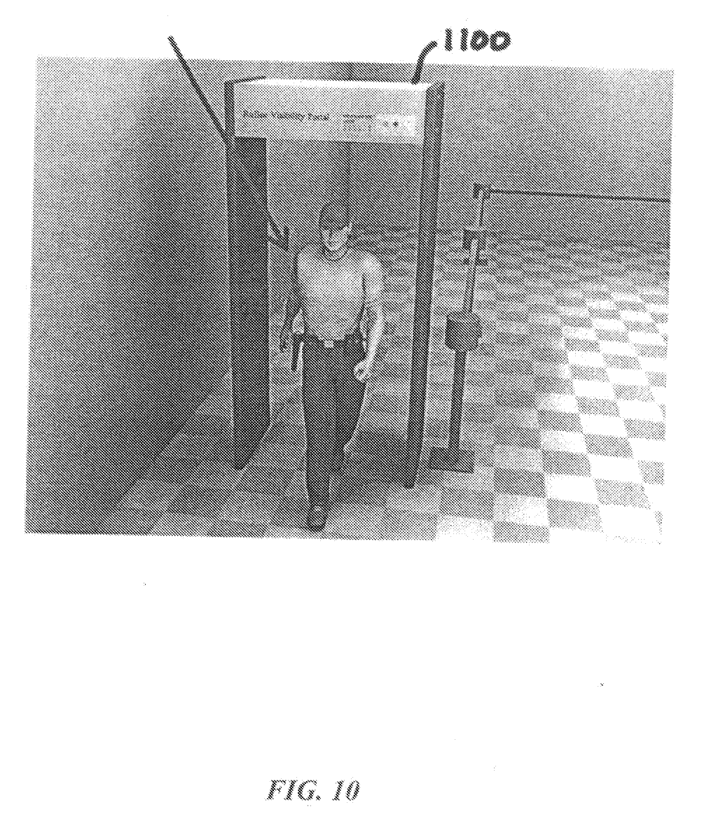

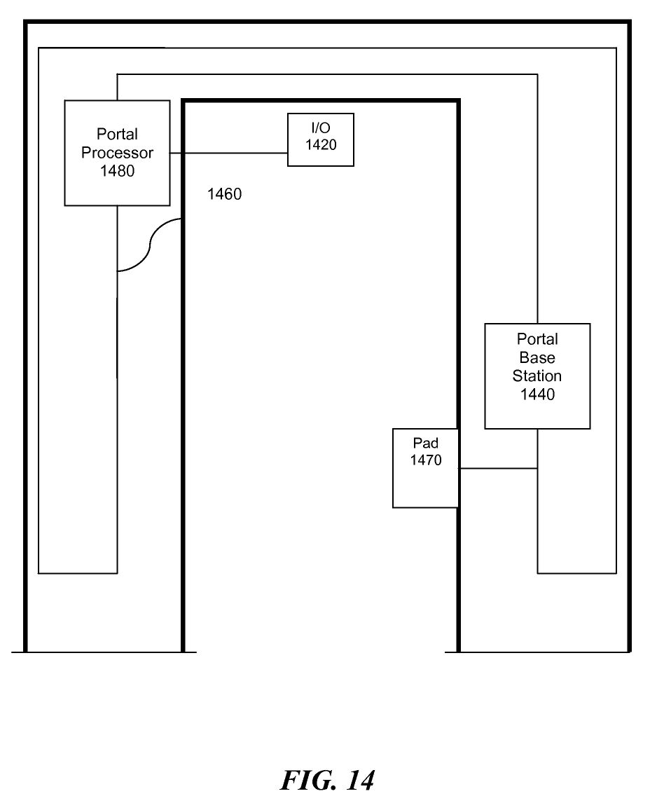

A standard visibility portal configured to read signals emitted from the security tag 150 is shown in FIG. 10. FIG. 10 shows a stand-alone walk-thru portal 1100 configured to read data from a security tag 150. In this embodiment using the portal 1100, one would simply set up a portal 1100 at each exit location. The components of the portal 1100 are shown in FIG. 14. The portal housing holds a loop antenna 1460 plus a base station or router 1440 and a small computer 1480, such as an ARM®-based RISC (reduced instruction set computer) processor. The ARM®-based processor may be physically connected to a computer network within the facility 300 via standard RJ45 connectors to send and receive messages. It may also be operatively connected via wireless transmissions. Affixed to the portal housing is a pad 1470 acting as a transceiver, operable to pick up signals from a security tag 150 and also to transmit signals to a tag 150 within range. As an individual carrying a portable device 100 passes through the portal 1100, the portal, or reader, is able to identify the portable device 100 as a restricted device because of its tag 150.

The portal 1100 may be configured such that it detects the proximity of a portable device 100 and emits a warning signal. The portal 1100 may optionally contain an input/output device 1420 such as a display screen, or an audio device. The warning signal may be picked up by a monitoring station which would then take action. Alternatively, the portal 1100 itself may act as a monitoring station and take whatever action is necessary, such as broadcasting a warning message that a portable device 100 is about to leave the secure area.

The monitoring station or the portal 1100 could also transmit a signal to cause access to the data in the portable device 100 to be disabled. The step of issuing a warning signal may be bypassed and instead, data access may be instantly disabled once the portable device 100 passes through the portal 1100. This may be accomplished by transmitting or failing to transmit an instruction to set (or re-set) a flag 104 in the tag 1501. The portal may be a unipolar portal, as shown and discussed in “Firearm Visibility Network,” U.S. Application Ser. No. 60/913,656.

You will recall that an optional ID section 195 of the tag 150 contains data identifying the device 100, the user of the device 100, and/or the organization that owns the device 100. Data from this ID section 195 could be read by the portal 1100. In this manner information about the device 100 and/or the individual carrying the device 100 could be transmitted to a monitoring station and/or remote computer.

According to another embodiment of the present invention, the device 100 may contain a separate battery 112 as shown in FIG. 13. This battery 112 has only one use. It remains off until it is activated by the microprocessor 180, which is configured to receive a specific signal. Once this battery 112 has been activated by the microprocessor 180, the battery 112 operates a squib device 185, destroying the data in the laptop 100. The tag 150 is operable to receive a plurality of signals to allow the microprocessor to drive many input/output devices, including one to start a data delete response. These signals may be transmitted at different radio frequencies. One radio frequency may be reserved for a data erase directive, one radio frequency may be used for an identification signal, while another radio frequency is used for all other directives. The tag 150 is operable to receive radio frequency signals varying in strength, some as low as 150 kHz.

Rather than using the battery 112 to power up a squib 185, the battery 112 may also be used to set the switch 104. In one embodiment, when the switch 104 is in the “On” position, the controller 427 intercepts any read/write requests to the hard drive 425 and does not allow them to go through. This configuration requires two enablements: 1) the controller 427 must be operatively connected to the tag 150, and 2) the controller 427 must be pre-programmed with the switch settings. As an added feature, an appropriate error message may be sent to a user. The switch 104 may also be activated by the microcontroller 180, instead of the additional battery 112.

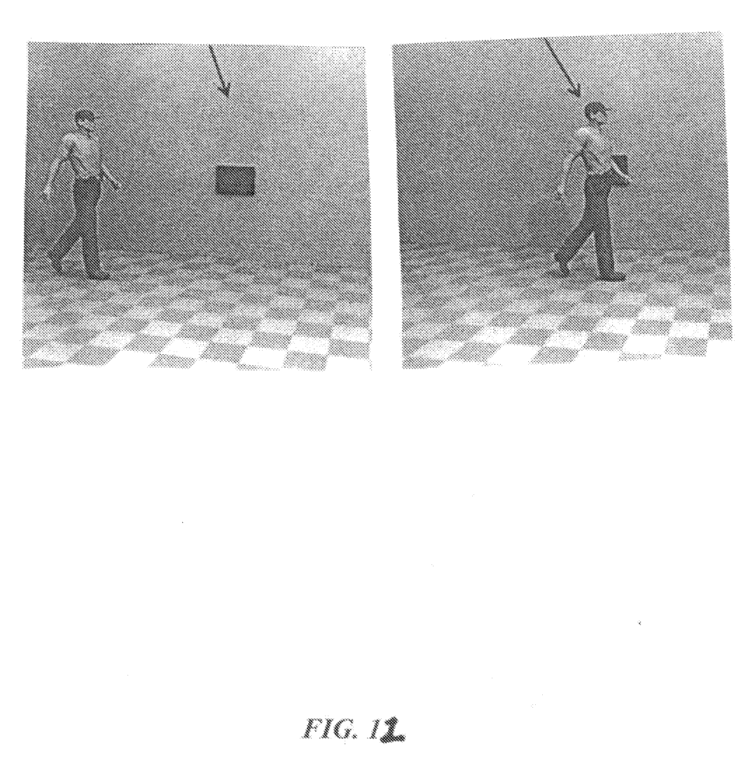

FIG. 11 shows a wall-mounted portal configured to read data from the portable devices. The advantage of the wall-mounted portal as shown in FIG. 11 is that it is inexpensive and very easy to set up.

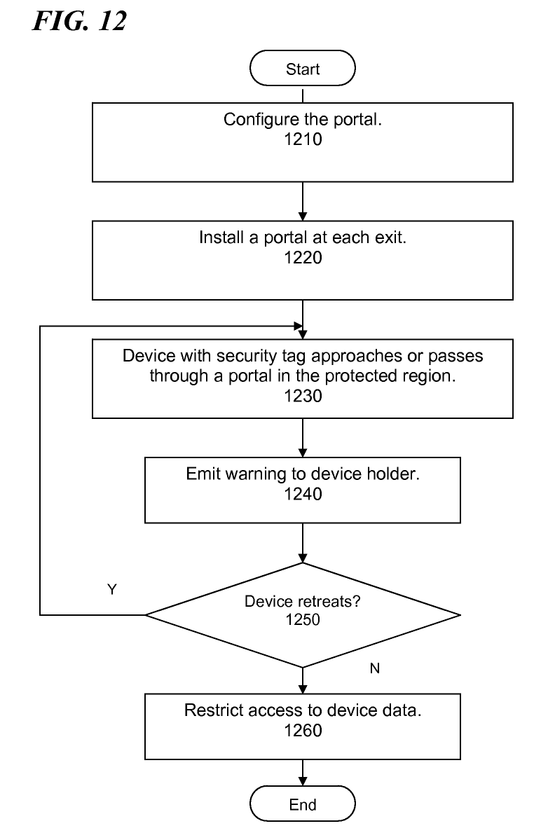

Referring now to the flow chart of FIG. 12 we discuss an alternate method of exit control using a portal 1100. The first step 1210 is to configure the portal 1100. This step involves either configuring the portal 1100 with a RISC processor already pre-loaded with instructions, or programming the processor after it is installed. Next, in step 1220 a portal 1100 is installed at each exit to a secure area 300. In step 1230 a device 100 containing a security tag 150 approaches or passes through the portal 1100, indicating that the device 100 is leaving the secure area 300.

An optional step 1240 of emitting a warning to the holder of the device 100 may be incorporated in this process. This optional warning is used for an individual mistakenly leaving the secure area 300 with a portable device 100. After the warning is transmitted, the individual is given a small interval of time (perhaps three seconds) to retreat back into the protected region 300. If the device 100 is still within the portal area after the warning interval (step 1250), the device data access is restricted in step 1260. This means no reads or writes can occur. Perhaps the data itself may be erased.

Optionally, if no warning signal is given, the portal 1100 automatically transmits a signal to restrict the data access. If, however, the device 100 retreats from the portal area back into the protected region 300, the process loops back to step 1230 where the portal 1100 is in wait mode.

Therefore, while there have been described what are presently considered to be the preferred embodiments, it will understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

We claim:

1. A networked security tag affixed to a portable computing device for monitoring, tracking, and securing the portable computing device within a protected region, the security tag comprising:
a security program;
an omni-directional device antenna operable at a low radio frequency not exceeding one megahertz;
a transceiver operatively connected to the device antenna, the transceiver operable to receive radio signals at the low radio frequency and generate data signals at the said low radio frequency, in response thereto;
a programmable microcontroller operatively coupled with the transceiver, the microcontroller configured for controlling operation of the security program and to cause the transceiver to emit a signal.

2. The security tag of claim 1, wherein the low radio frequency not exceeding 300 kilohertz.

3. The security tag of claim 2, wherein some of the signals are transmitted at a low radio frequency not exceeding 150 kilohertz.

4. The security tag of claim 1, further comprising an identification storage section operatively connected to the security program, the identification storage section comprising identification data about the portable computing device, the identification data comprising a unique identifier associated with said portable computing device.

5. The security tag of claim 4, wherein the identification data comprises an internet protocol address, and wherein the microcontroller is operable for communication with an internet router using said internet protocol address, such that at least a portion of the identification data can be transmitted through the internet router to be viewable through a web browser at a remote location.

6. The security tag of claim 4 wherein the identification data is inserted by the microcontroller upon receipt of a directive sent as a signal from a trusted source.

7. The security tag of claim 4 wherein the identification storage section further comprises network identification data.

8. The security tag of claim 7, wherein the security tag is operable to transmit and receive signals from other security tags within its network.

9. The security tag of claim 1 wherein the transceiver is operable to emit a warning signal when the portable computing device is being removed from the secure region.

10. The security tag of claim 1 further comprising at least one energy source.

11. The security tag of claim 1 wherein the security program is embodied as an application specific integrated circuit.

12. The security tag of claim 1 wherein the security program is embodied within the microcontroller.

13. The security tag of claim 1 further comprising:
a memory for storing data; and
a timing device operatively connected to the transceiver, the timing device operable to:
activate said transceiver at selected time intervals, and
create timestamps that are tied to status events, wherein a temporal history of the status events can be stored in the memory.

14. The security tag of claim 13 wherein the timing device is a crystal providing random phase modulation for enabling a selective read of a specific security tag within a network of security tags, without prior knowledge of its identification.

15. The security tag of claim 1 further comprising at least one sensor for detecting at least one condition, wherein the at least one sensor is operable to emit an on-demand transmission signal when the at least one condition is detected and wherein the microcontroller is able to detect and read said signal from the at least one sensor, and further is able to take appropriate action based on the signal received.

16. The security tag of claim 15 wherein the at least one sensor is a global positioning signal sensor for locating the portable computing device.

17. The security tag of claim 1 wherein the security tag is operatively connected to a hard drive controller in the portable computing device.

18. The security tag of claim 17 further comprising:
at least one switch, each switch comprising a plurality of modes, wherein the at least one switch remains set to enable mode for a predetermined interval of time, responsive to signals from the base station, and wherein the at least one switch is set to disable mode once the predetermined interval of time has elapsed.

19. The security tag of claim 17 further comprising a heat-generating device for causing erasure of data in the portable computing device and wherein the microcontroller is further configured for actuating the heat-generating device in response to receiving an erase signal, said erase signal emitted if the portable computing device is removed from the protected region.

20. The security tag of claim 17 wherein the at least one energy source is maintained in sleep mode until activated by the microcontroller to set a switch to indicate that access to data in the portable computing device should be restricted.

21. The security tag of claim 17 wherein the at least one energy source is for activating a heat-generating device to destroy data in the portable computing device.

22. A method for securing data in a portable computing device within a protected region, the method comprising steps of:
configuring a signal generating system within the protected region, the signal generating system comprising at least one field antenna and a base station operable to generate a low frequency radio signal not exceeding one megahertz;
configuring the portable computing device with a security tag, the security tag comprising:
a low frequency transceiver, a microcontroller, an antenna operable at said low frequency, and a security program for secure use within the protected region;
monitoring the portable computing device within the protected region;
enabling user access to the data in the portable computing device when the portable computing device is within the protected region; and
restricting user access to the data in the portable computing device when the portable computing device is outside of the protected region.

23. The method of claim 22 further comprising installing a portal comprising a router, a loop antenna, and a processor.

24. The method of claim 23 further comprising emitting a warning when the portable computing device is in close proximity to the portal.

25. The method of claim 22 wherein the step of restricting user access comprises at least one action selected from a group consisting of: erasing data, destroying data, degaussing a hard drive, writing over data, changing a security code, and modifying a decryption key.

26. The method of claim 22 further comprising:
installing a heat-generating device, said heat-generating device operable by the microcontroller, wherein erasure of the data in the portable computing device is accomplished by activating the heat-generating device to release energy sufficient to destroy the data, and wherein the heat-generating device is activated when the portable computing device is removed from the protected region.

27. The method of claim 26 wherein the heat-generating device is activated by the microcontroller to emit a high voltage electro magnetic signal causing erasure of the data in the portable computing device when the portable computing device is removed from the protected region.

28. The method of claim 22 wherein the base station transmits interrogation signals to the security tag and waits for a timely response from the security tag, and wherein user access to the portable computing device is restricted when the timely response is not received at the base station.

29. The method of claim 28 wherein the interrogation signals are transmitted periodically.

30. The method of claim 22 further comprising transmitting interrogation signals to the security tag with the at least one field antenna.

31. The method of claim 22 further comprising using the security tag for transmitting identification signals to the base station at timed intervals and if the base station fails to receive an identification signal at the timed interval, the base station transmits a signal restricting access to the data in the portable computing device.

32. The method of claim 25 further comprising steps of:
loading an encryption/decryption program in the security tag, along with a key, and
restricting user access by transmission of a signal to the microcontroller causing said microcontroller to modify the key.

33. The method of claim 25 wherein restricting user access further comprises requiring the user to provide a security code transmitted by the base station and changing said security code if the portable computing device is removed from the protected region.

34. The method of claim 33 wherein the security code is updated periodically and wherein the updated security code is transmitted to the security tag only if the portable computing device is within the protected region.

35. The method of claim 22 wherein the security tag is configured to emit a warning signal when it is removed from the protected region.

36. The method of claim 22 wherein configuring the portable computing device further comprises installing a battery in the security tag, said battery in a sleep state until activated by the microcontroller, wherein activating the battery causes a release of energy, the energy destroying data in the portable computing device.

37. The method of claim 36 further comprising a step of:
installing a squib device in the security tag, wherein the battery activates the squib device, said squib device releasing heat to destroy data in the portable computing device.

38. The method of claim 22, further comprising a step of locating the security tag device using global positioning system signals.

39. The method of claim 22, further comprising steps of:
installing a timing device in the security tag and
setting at least one switch, wherein the at least one switch remains set to enable mode for a predetermined interval of time, responsive to signals from the base station, and wherein the at least one switch is set to disable mode once the predetermined interval of time passes.

40. A system for tracking, monitoring, and securing at least one portable computing device within a protected region, the system comprising:
a networked security tag affixed to each portable computing device, the security tag operable to receive and transmit low frequency radio signals not exceeding one megahertz;
a base station operable to generate the low frequency radio signals throughout substantially an entirety of the protected region, the base station comprising logic circuitry, a radio modem circuit, and an antenna; and
at least one field antenna for radiating the low frequency radio signals driven by the base station.

41. The system of claim 40 further comprising a computer for monitoring the at least one portable computing device.

42. The system of claim 40 further comprising a portal configured to read data from the security tag, the portal comprising a loop antenna, a router, and a processor.
